(19) United States
(12) Patent Application Publication
(10) Pub. No.: US 2008/0137194 A1
(43) Pub. Date: Jun. 12, 2008

(54) Diffractive Filter

(75) Inventor: Alexander Stuck, Wettingen (CH)

Correspondence Address: FISH & RICHARDSON, PC, P.O. BOX 1022, MINNEAPOLIS, MN, 55440-1022, US

(73) Assignee: CSEM CENTRE SUISSE D'ELECTRONIQUE ET DE MICROTECHN, Neuchatel (CH)

(21) Appl. No.: 11/579,764

(22) PCT Filed: May 4, 2005
(86) PCT No.: PCT/IB05/01701

§ 371 Date: Nov. 7, 2006

(30) Foreign Application Priority Data
May 7, 2004 (GB) 0410245.5

(51) Int. Cl. G02B 27/44

(52) U.S. Cl. 359/568

(57) ABSTRACT

A diffractive optical filter comprises a bulk material (1) having a first refractive index, a volume diffraction grating structure (2,3) having a second, different, refractive index embedded in the bulk material (1), and a mirror (4) formed within or on the surface of the bulk material (1) behind the grating structure (2,3). By placing the mirror (4) immediately behind the grating structure (2,3) the diffractive structure is effectively doubled and consequently the number of effective optically active layer is doubled. Such diffractive optical filters may be used as diffractive identification devices bonded to articles whose authenticity needs to be established.

The invention relates to diffractive filters. The invention further relates to a diffractive identification device and to an authenticated item in which such an identification device is embedded. The invention still further relates to a method of fabricating a diffractive identification device.

It is known that optical gratings with micron or sub-micron feature size can be used to produce colour effects. Combining such gratings with embedded structures and wave guide structures can produce angle dependent rotational colour effects. This technique has been used in authenticating devices. Such use has been described in a paper entitled “Zero-Order Diffractive Microstructures for Security Applications” by M. T. Gale K. Knop and R. Morf published in SPIE Vol 1210 Optical Security and Anticounterfeiting Systems (1990) pages 83-89.

U.S. Pat. No. 4,484,797 describes a diffractive subtractive colour filter that exhibits colour shifts when rotated. It is based buried diffraction gratings and this technology has been used for security applications. This patent describes methods for producing such diffractive filters and describes how to obtain a filter having two optical interference layers. Current technology allows the manufacturer of such devices with two optical interference layers. The production of more than two layers is not cost effective at present.

In a first aspect, the invention provides a diffractive optical filter comprising a bulk material having a first refractive index, a volume diffraction grating structure with a different refractive index embedded in the bulk material, and a mirror formed within or on the surface of the bulk material behind the grating structure.

As stated above, combining gratings with embedded structures and wave guide structures can produce angle dependent rotational colour effects which can be used as authenticating devices. Current technology, however, does not allow the cost effective manufacture of grating structures with more than two layers. By placing a mirror immediately behind the grating structure the diffractive structure is effectively doubled and consequently the number of optically active layers is effectively doubled. In this way a relatively inexpensive method of obtaining more than two optical grating layers is provided.

Such diffractive optical filters may be used as diffractive identification devices that may be bonded to an article whose authenticity needs to be established. For example, they may be used as security features on credit cards, bank notes and postage stamps, or other articles of high value that may be subject to counterfeiting.

In a further aspect, the invention provides a method of fabricating a diffractive identification device comprising the steps of; forming one or more layers of a periodic refractive index modulation in a bulk material and forming a mirror on one side of the bulk material so that it is parallel to and overlaps the layers of periodic refractive index modulation.

The above and other features and advantages of the invention will be apparent from the following description, by way of example, of embodiments of the invention with reference to the accompanying drawings in which:

FIG. 1 shows a diffractive optical filter of prior art form,

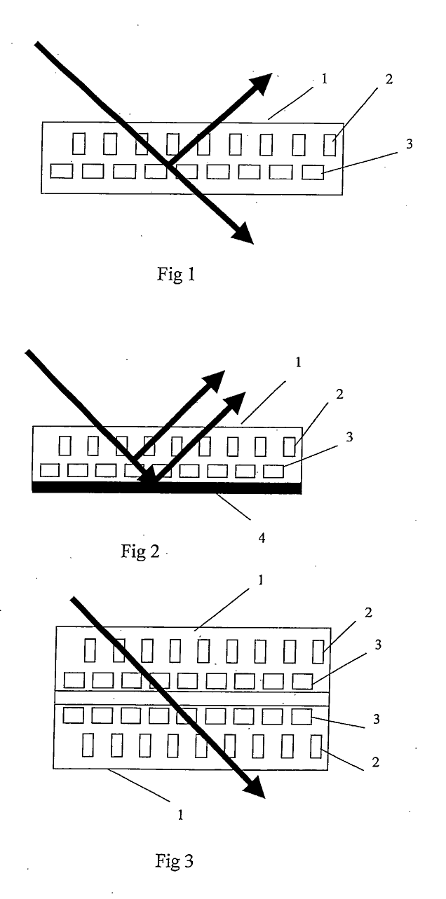

FIG. 2 shows a diffractive optical filter according to the invention,

FIG. 3 shows the optical equivalent of the physical structure shown in FIG. 2, and

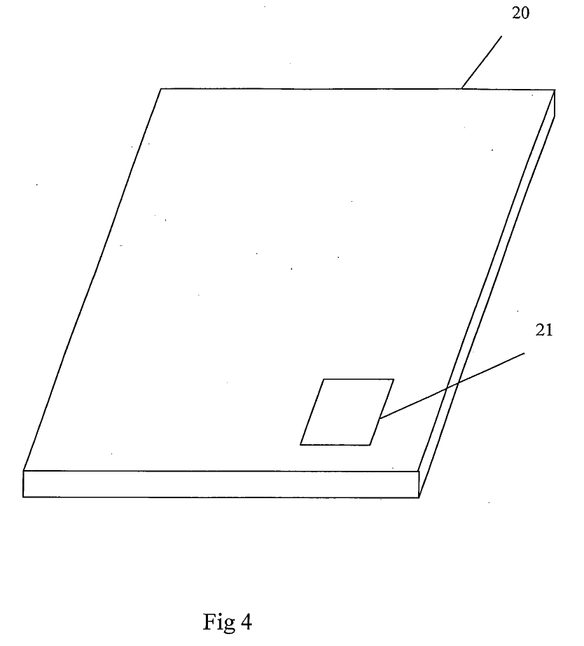

FIG. 4 shows an item with a diffractive identification device bonded thereto.

FIG. 1 shows a typical structure for a diffractive optical filter, which may be used a diffractive identification device. It comprises a bulk material 1 having a first refractive index n1 and first and second periodic gratings 2 and 3 of a material with a refractive index n2 different from that of the bulk of the material. The two gratings 2 and 3 are embedded on two different levels. This may be achieved, for example, by means of the method described in U.S. Pat. No. 4,484,797, the contents of which are hereby incorporated by reference. The provision of two levels of grating has been achieved in a cost effective manner, but at present it is extremely difficult to add more grating levels in perfect registry with one another. It will be appreciated that the gratings have periods that are typically smaller than the wavelength of light, i.e. less than 1 micrometer.

FIG. 2 shows a diffractive optical filter according to the invention in which effectively more layers of grating are provided in a manner that is relatively simple to manufacture. The principle is to add a mirror 4 on the rear surface of the bulk material, which effectively doubles the number of optically active layers without the need to manufacture further levels. FIG. 3 shows the optical equivalent of the physical structure shown in FIG. 2. The mirror 4 in FIG. 2 effectively doubles the number of optically active layers.

In order to produce an optical filter according to the invention the following processing steps may be undertaken. First a conventional optical filter structure such as that shown in U.S. Pat. No. 4,484,797 is constructed by any convenient method, for example the method described in that patent. Subsequently, a mirror is deposited onto one side of the bulk material 1. The mirror may take any convenient form, for example a simple metal deposition on the surface of the bulk material. Any metal can be evaporated onto a flat surface to give a mirror. Typically, the metals aluminium, silver or gold are used. The spectral response of the mirror may be tuned by the choice of metal or alloy. Gold, for example, will mostly reflect yellow and red light and allow little reflection of blue and green. The reflection coefficient may be manipulated by controlling the thickness of the metal. If only a few 10 nm are deposited, partial reflection is achieved. If the metal layer is a few 100 nm thick, then full reflection is achieved.

Alternatively, a coloured mirror may be provided using pigments or by a choice of metal cluster size. Small metal particles, a few atoms or a few hundred atoms in size have a different optical spectrum from the bulk metal material. The optical spectrum of such clusters strongly depends on the cluster size. Small particles of gold, for example, are black not yellow. The yellow only appears in bulk gold. By tightly controlling the cluster size and the deposition of these clusters on a surface, a mirror with selective reflectivity in certain wavelengths can be formed. Such clusters are typically generated by sputtering the metal onto the surface. Such metal layers are extremely thin by definition. It is essential for the functioning of these mirrors that the different clusters do not aggregate on the surface but remain separated. Again, typical metals are gold, copper, aluminium and silver.

Further, a dielectric interference mirror may alternatively be provided. Interference mirrors with tuneable wavelength characteristics can be manufactured by depositing stacks of layers with different refractive indexes and different thicknesses onto a surface. This approach is widely used in the optics industry. Typical materials are stacks of different metal oxides, also SiO2, and polymer/calcegonide/metal oxide systems.

In principle there is provided a combination of a sub-wavelength interference structure for security applications with a selective or non-selective mirror surface. This overcomes the limitations of the prior art in which such digital identification devices having more than two interference levels cannot be readily manufactured. The present invention allows the manufacture of much more complex diffractive identification devices than are currently possible. In particular, it provides optical registry between the mirrored interference levels and the actual physical structure.

FIG. 4 shows an item to be authenticated. The item 20 has a diffractive identification device 21 embedded therein. The identification 21 may be embedded by any convenient manufacturing process and embedding is intended to include bonding the device to the surface of the article 20.

An optical zero order diffraction grating combined with a selective or non-selective optical mirror close to the grating operates to produce a very strongly angularly dependent reflection spectrum if it meets certain specified constraints with respect to relative refractive indices of its internal structure and that of its surroundings and relative values of incident wavelength to the periodicities of the grating and the distance to the mirror. Such gratings may be used as authenticating devices in industrial security applications. By providing the optical mirror close to the grating, a more complex grating structure may be obtained without requiring complex manufacturing processes, since the grating structure is effectively used twice.

1. A diffractive optical filter comprising a bulk material having a first refractive index, a volume diffraction grating structure having a second, different, refractive index embedded in the bulk material, and a mirror formed within or on the surface of the bulk material behind the grating structure.

2. A filter as claimed in claim 1 in which the grating structure has two optical interference layers.

3. A filter as claimed in claim 1 comprising a sub wavelength interference structure.

4. A filter as claimed in claim 2 comprising a sub wavelength interference structure.

5. A diffractive identification device comprising a filter as claimed in claim 1.

6. An article potentially subject to counterfeiting to which a diffractive identification device according to claim 5 is bonded.

7. A method of fabricating a diffractive identification device comprising the steps of:
forming one or more layers of a periodic refractive index modulation in a bulk material, and
forming a mirror on one side of the bulk material so that it is parallel to and overlaps the layer(s) periodic refractive index modulation.

8. (canceled)
